(19) United States
(12) Patent Application Publication
(10) Pub. No.: US 2008/0277939 A1
(43) Pub. Date: Nov. 13, 2008

(54) Linear Generator and System to Capture Energy from Irregular Linear Movement

(75) Inventors: Grover Richardson, Winston, GA (US); Gary Gray, Marietta, GA (US); Charles M. Stancil, Marietta, GA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: GEORGIA TECH RESEARCH CORPORATION, Atlanta, GA (US)

(21) Appl. No.: 10/592,902

(22) PCT Filed: Mar. 15, 2005
(86) PCT No.: PCT/US2005/008663

§ 371 Date: Jul. 29, 2008

Related U.S. Application Data
(60) Provisional application No. 60/553,219, filed on Mar. 15, 2004.

(51) Int. Cl. H02J 7/14

(52) U.S. Cl. 290/50; 320/137

(57) ABSTRACT

A system for capturing and storing electrical energy from irregular limited reciprocal linear movement along a cylinder, such as a shock absorber of a vehicle. A linear generator with electrical coils is wound around the cylinder parallel to the movement of the cylinder or along the cylinder. The electrical current generated by the linear generator can be stored in a battery. The energy from the recoil of a large military gun can also be captured by a linear generator along the barrel of the gun and stored in the battery. A processing device can be included to control the flow of electric energy from the linear generator to the battery. The electrical current can pass through a filter and may be processed by a conditioner to limit the range of voltage generated by the linear generator.

### CROSS-REFERENCE TO RELATED APPLICATION

This application claims priority to copending U.S. provisional application entitled, “Linear Generator For Suspension System Energy Capture,” having Ser. No. 60/553,219 filed Mar. 15, 2004, which is entirely incorporated herein by reference.

### BACKGROUND OF THE INVENTION

1. Field of the Invention

This invention relates to a linear generator for generating electricity from the irregular movement of apparatus, vehicles, such as the up and down movement of vehicles in response to changes in the terrain over which the vehicles travel, and from the recoil of large weapons which can be captured by a linear generator and stored in batteries for future use.

2. Background of the Invention

There is a great deal of energy that is not profitably used because we have not had satisfactory systems for capturing and using the energy. For example, the energy that is generated by the spring and shock absorber damping of vehicles is not profitably used. This energy is basically converted to heat within the shock absorber damping system. The recoil from the firing of a large gun on a gun carriage, tank or other military vehicle is also not profitably used. This energy is hard to capture because the movement is an irregular movement. If this energy could be captured and converted into electricity, it could be readily stored in batteries for future use.

A number of hybrid vehicles have been introduced to the market in the last few years. These hybrid vehicles combine an internal combustion engine with an electric motor to power the vehicle. The internal combustion engine can either power the vehicle or use any surplus power to charge the batteries which are used for running the electric motor or motors to power the vehicle. Hybrid vehicles are making an impact in the automobile market. They are also being used on the heavy vehicles and hold a lot of promise for use on heavy military vehicles that frequently travel off-road. Hybrid vehicles improve the fuel efficiency by using any surplus power developed by the internal combustion engine and also during braking to generate electricity to charge the batteries for powering the electric motor to drive the vehicle or power other electrical devices.

There is a keen interest in making the hybrid vehicles even more efficient. Heavy off-road vehicles, such as heavy military equipment like tanks and armored personnel carriers, have considerable energy that is lost in the up and down movement of the vehicle over rough terrain or even on relatively smooth terrain. These movements can be dampened by shock absorbers and springs, but the energy generated is not put to any practical use. In fact, the energy produces heat which is undesirable. This is also true of vehicles such as tanks and self-propelled guns where a lot of energy is also created in the recoil of the gun when it is fired. The efficiency of these heavy vehicles could be improved if the up and down energy of the vehicle moving over terrain with bumps could be captured and stored in batteries for future use. This would be particularly useful to heavy military vehicles that travel off road and consequently generate a great deal of energy by up and down movement over bumps and irregularities in the terrain. Improving the efficiency of these heavy military vehicles is important, as it is frequently difficult to supply these vehicles with fuel during combat.

### SUMMARY OF THE INVENTION

This invention provides a system for capturing and storing electrical energy from the irregular or sporadic limited reciprocal linear movement along the length of a cylinder, which could be a shock absorber or the barrel of a large military gun. A linear generator with electrical coils is wound around the length of the cylinder parallel to the movement of the cylinder or movement of a rod and piston in the cylinder. The linear generator is capable of converting a large portion of the energy of movement along the cylinder into electricity. This electricity can be stored in a battery or used for powering electric motors that drive the vehicle or other appliances. The current from the linear generator can be passed through filters that may include a bridge rectifier circuit and a capacitor before it reaches the battery. A processing device can be provided to shut the current the off and on or to divert it from the battery for another use.

Because a vehicle on rough terrain may encounter both large bumps and small bumps, it is preferable that the shock absorber assembly has a primary linear generator and two secondary linear generators. The primary linear generator is designed to convert the energy from a large bump and the two secondary linear generators are designed to produce current from small bumps. As the electrical current produced by the linear shock absorber that passes through a filter is irregular in voltage, the current can be passed through a conditioner which is also controlled by a processing device in the vehicle. This conditioner can limit the range of the voltage that is conducted to the battery.

Of course, all four wheels of the vehicle can have linear generator shock absorbers, with either a single shock absorber for a wheel or a primary and two secondary shock absorbers per wheel.

The processing device may use a program for the conditioner and the off and on switches from the various linear generators to achieve the desired charge of the battery and powering of any other motor or electric appliance.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a perspective view of a shock absorber assembly for a vehicle in which a linear generator replaces the conventional shock absorber.

FIG. 2 is cross sectional view of the linear generator shock absorber of FIG. 1.

FIG. 3 is a graph showing the voltage variation over distance traveled by the vehicle in which the linear generator shock absorber is installed.

FIG. 4 is a cross section of the linear generator shock absorber with a primary and two secondary linear generators.

FIG. 5 is a graph showing the variation in the voltage supplied by a linear generator and processed through a power conditioner to limit the voltage variation.

FIG. 6 is a circuit diagram for processing the electricity generated by a single linear generator shock absorber as shown in FIGS. 1 and 2.

FIG. 7 is a circuit diagram for a shock absorber assembly that has a primary linear generator and two secondary linear generators as illustrated in FIG. 4.

FIG. 8 is a circuit diagram for four separate linear generator shock absorbers as would be found on a four wheel vehicle.

FIG. 9 is a perspective view of the self-propelled howitzer which has a primary linear generator for generating current from the recoil of the gun.

### DETAILED DESCRIPTION OF THE PREFERRED EMBODIMENT

It has been found that a linear generator can be used to capture the energy that otherwise is not profitably utilized in situations involving the irregular movement of a cylinder, such as a shock absorber on a vehicle or a large gun barrel during recoil. One application where this invention is particularly promising is in respect to replacing the spring and shock absorber damping system on a vehicle with linear generation equipment. The linear generator is designed so that the reactive motion of the suspension system is dampened by the back-electromotive force in the generator.

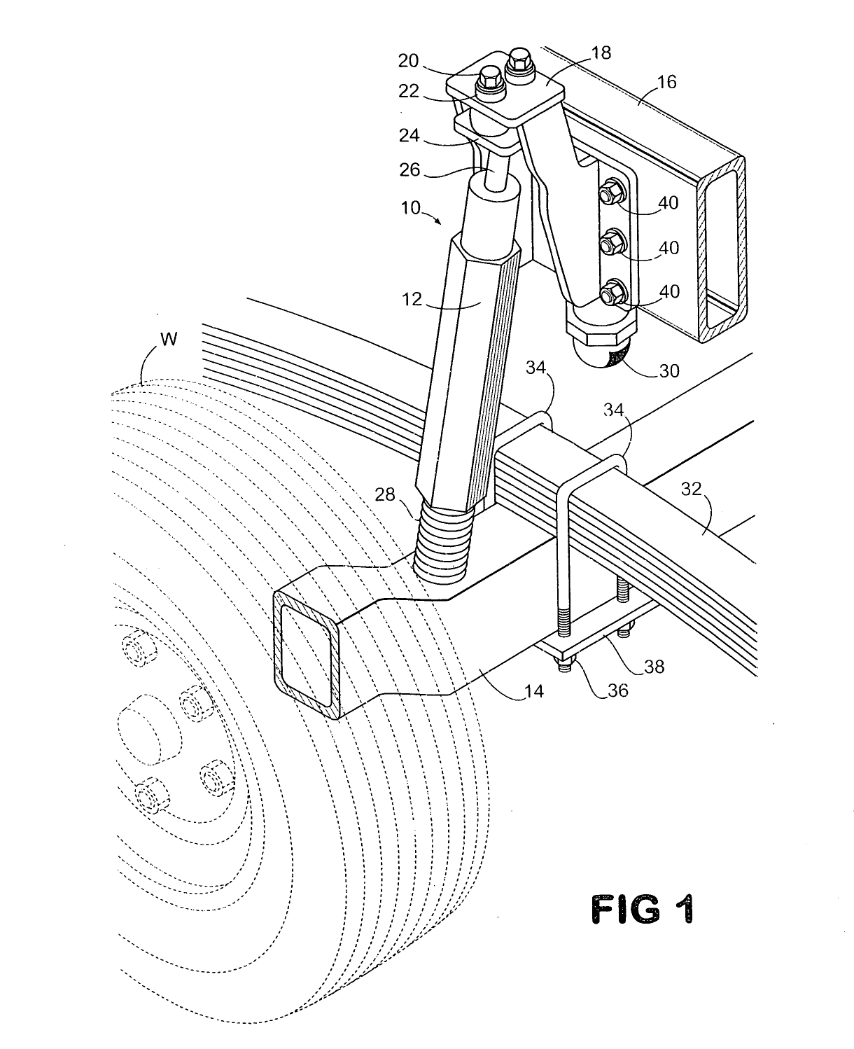

FIG. 1 shows a linear generator shock absorber having replaced the standard shock absorber in a vehicle. This shock absorber assembly 10 has a linear generator shock absorber 12 which is attached to the axle 14 of the vehicle to which a wheel W is attached. The shock absorber assembly 12 is attached to the frame 16 of the vehicle by a strut 18. The strut 18 is attached to the frame 16 by a nut and bolt 40 fastening system. The strut 18 is attached to the linear generator shock absorber 12 by bolts 20 secured by nuts 22, with the bolts 20 extending through plate 24 which is attached to rod 26 which extends into the linear generator shock absorber 12 and is attached to a piston (not shown). The linear generator shock absorber 12 is attached to the axle 14 by one or more bolts (not shown). A dust cover 28 covers these bolts. This shock absorber assembly 10 utilizes a spring 32 that is attached to the axle 14 by a clamp 34 secured by nuts 36. A plate 38 connects the two clamps 34 together. It should be realized that the linear generator shock absorber 12 could replace the spring 32 entirely or only replace the standard shock absorber. A bumper 30 is provided to prevent excessive movement of the wheel on the vehicle in relation to the frame.

As the vehicle on which the linear generator shock absorber 12 is installed moves over terrain with irregularities, the wheel attached to shock absorber assembly 10 moves up and down. The linear generator generates electricity with this movement. The electricity can be supplied to a battery or otherwise used to supply electricity to certain electrical appliances. This linear generator shock absorber 12 can be designed to fit into the space normally taken up by a conventional shock absorber component on a vehicle. In the case of a hybrid vehicle with electric motors supplying a portion of the power to the wheels, the linear generator shock absorber can supply some of that power to those electric motors.

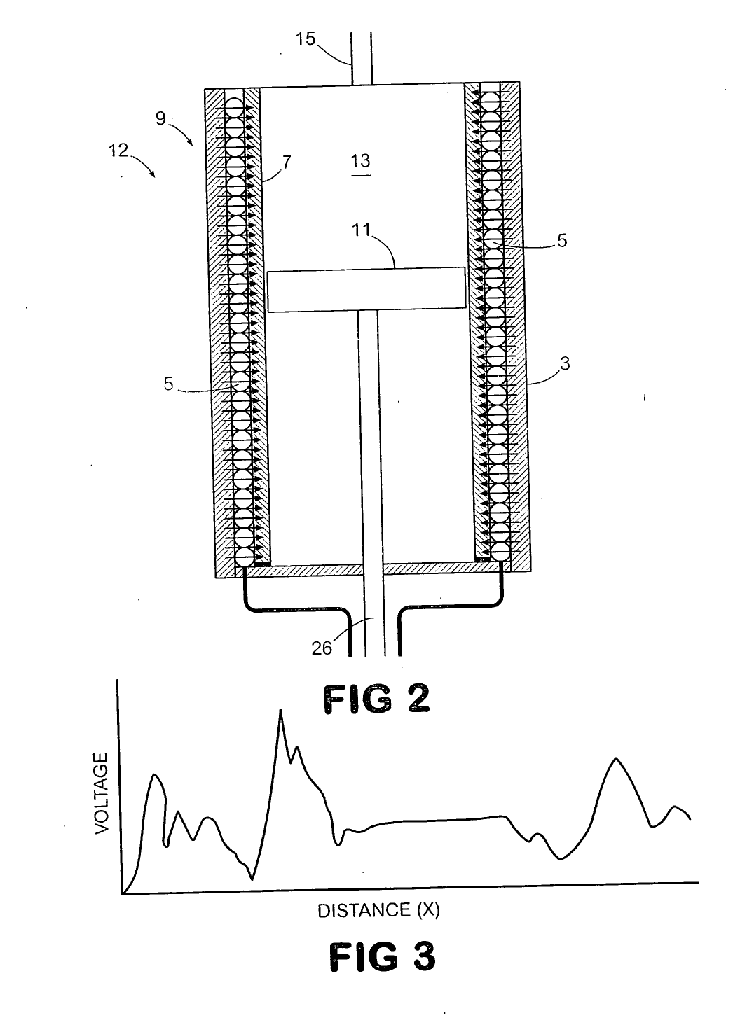

FIG. 2 is cross sectional view of the linear generator shock absorber 12 of FIG. 1. The linear generator shock absorber 12 includes a cylinder 9, electrical coils 5 and piston 11. The cylinder 9 has a chamber 13 through which the piston 11 travels. This chamber 13 may or may not be filled with a dampening fluid. The cylinder 9 is a portion of a shock absorber for a vehicle which is designed to absorb the shocks transmitted when the vehicle is moving on terrain with irregularities in the surface. The electrical coils 5 are wound around at least a substantial portion of the length of the cylinder 9 parallel to the movement of the piston 11 along the cylinder 9. The electrical coils 5 are supported in a stationary position in relation to the movement along the cylinder 9. More specifically, the electrical coils 5 are supported between inner wall 7 and outer wall 3 of the cylinder 9.

The piston 11 is attached to a piston shaft 26. The piston 11 moves along the length of the cylinder 9 as the vehicle moves on the terrain, and generates electricity with this movement. The piston shaft 26 can be connected to a damping device (not shown) that can dampen the movement of the piston 11 along the cylinder 9. The linear generator shock absorber 12 converts at least a substantial portion of the energy of the movement of the piston 11 along the cylinder 9 into electricity. The converted energy is operatively output to the battery via electrical connection 15.

FIG. 3 is a graph showing the voltage variation over distance traveled by the vehicle in which the linear generator shock absorber is installed. FIG. 3 shows the irregular energy generated by the shock absorber due to the “bumpy” terrain. A power conditioner (not shown) conditions the irregular energy to a controlled energy that cain have sinusoidal characteristics as shown in FIG. 5. The power conditioner can include a capacitor that is charged by the signal/pattern of the irregular energy. The capacitor stores the energy in a form that can be used by most any power management system. As the capacitor is being charged, a processing device determines whether the capacitor has sufficient energy to charge an energy-storing device, e.g., a battery. In short, the capacitor is a temporary energy “holding tank” that stores energy to be released to a battery based on the determination of the processing device. In addition, since the capacitor is DC, and many forms of power storage use DC systems, the output of the capacitor can be tailored into any form that is required by the end using system. For example, a switching regulator can be used to transform the voltage of the capacitor to match the voltage of the end using system, or to be used to charge a battery. In another example, a switching system can use the energy to generate 50, 60, or 400 hertz power for the end using system. By filtering and conversion, the irregular energy can be transformed to charge a battery or for charging an array of capacitors that would provide power output for short duration.

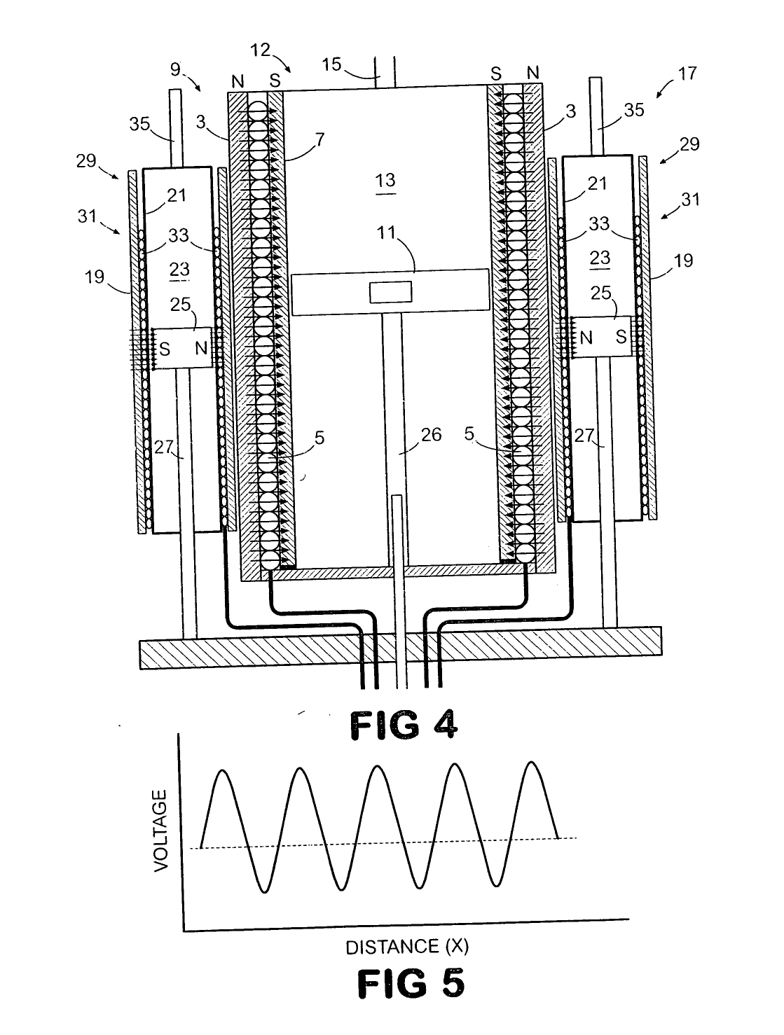

FIG. 4 is a cross section of the linear generator shock absorber with a primary and two secondary linear generators. The linear generator shock absorber includes the primary linear generator 12 which has similar electrical components described above in relation to FIG. 2 and therefore includes a cylinder 9, piston 11, and electrical coils 5. The two secondary linear generators 31 are similar to the primary linear generator 12 and therefore include chambers 23, cylinders 29, pistons 25, and electrical coils 33. In each of the secondary linear generators 31, the electrical coils 33 are wound around at least a substantial portion of the length of the cylinder 29 parallel to the movement of the piston 25 along the cylinder 29. The electrical coils 33 are supported in a stationary position in relation to the movement of the piston 25 along the cylinder 29. More specifically, the electrical coils 33 are supported between inner wall 21 and outer wall 19 of the cylinder 29.

The piston 25 is attached to a piston shaft 27. The piston 25 moves along the length of the cylinder 29 as the vehicle moves on the terrain, and generates electricity with this movement. The piston shaft 27 can be connected to a damping device (not shown) that can dampen the movement of the piston 25 along the cylinders 29. The two secondary linear generator shock absorbers 31 convert at least a substantial portion of the energy of the movement of the piston 25 along the cylinder 29 into electricity. The converted energy is operatively output to the battery via electrical connection 35.

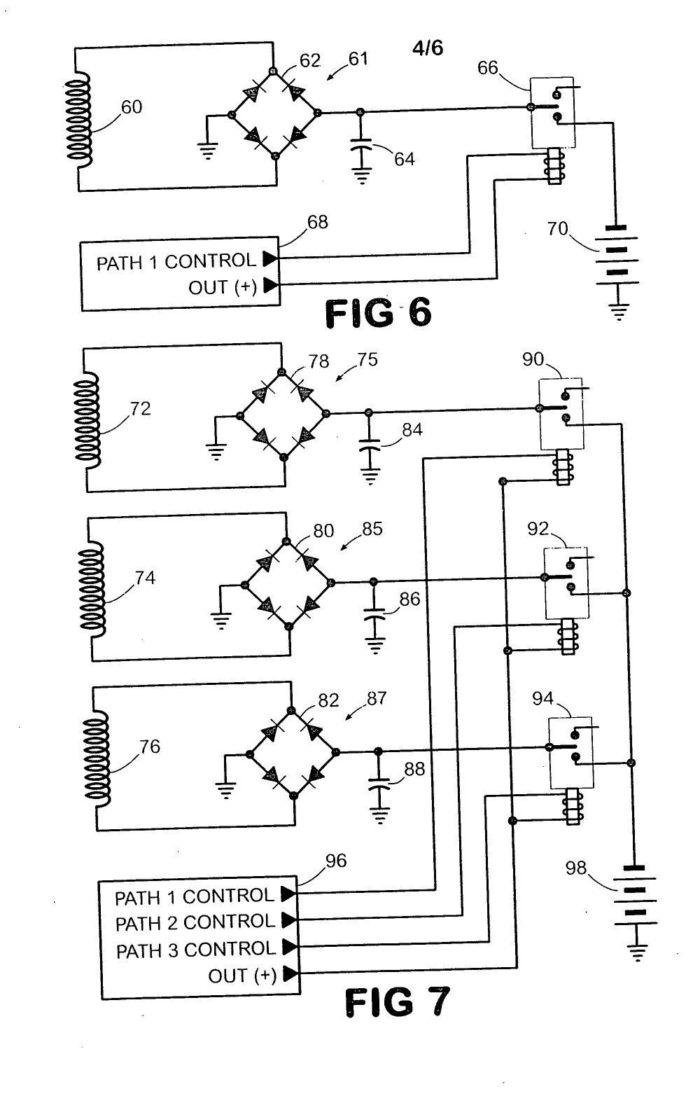

FIG. 6 is a circuit diagram for processing the electricity generated by a single linear generator shock absorber 12 as shown in FIGS. 1 and 2. The single linear generator shock absorber 60 is coupled to a filter 61 that filters converted energy from the linear generator shock absorber 60 and operatively outputs filtered energy to the battery 70. The filter 61 includes, for example, a bridge rectifier circuit 62 and a capacitor 64. Other filters can be used such as a RC filter. The filtered energy from the filter 61 is received by a switch 66 that connects or disconnects the linear generator 60 to the battery 70. A processing device 68 is connected to the switch 66 and is capable of sensing the filtered energy from the filter 61. The processing device 68 is also capable of determining whether to connect or disconnect the linear generator 60 to the battery 70 based upon the filtered energy from the filter 61. In addition, the processing device 68 is capable of controlling the switch 66 to connect or disconnect the linear generator 60 to the battery 70.

The processing device of 68 may disconnect the linear generator 60 from the battery 70 when the battery is fully charged. It may also disconnect the linear generator 60 from the battery 70 and attach it to another appliance or electric motor, such as a motor for driving the vehicle. The processing device can also be programmed to connect the linear generator 60 to the battery 70 when the battery 70 reaches a certain state of discharge.

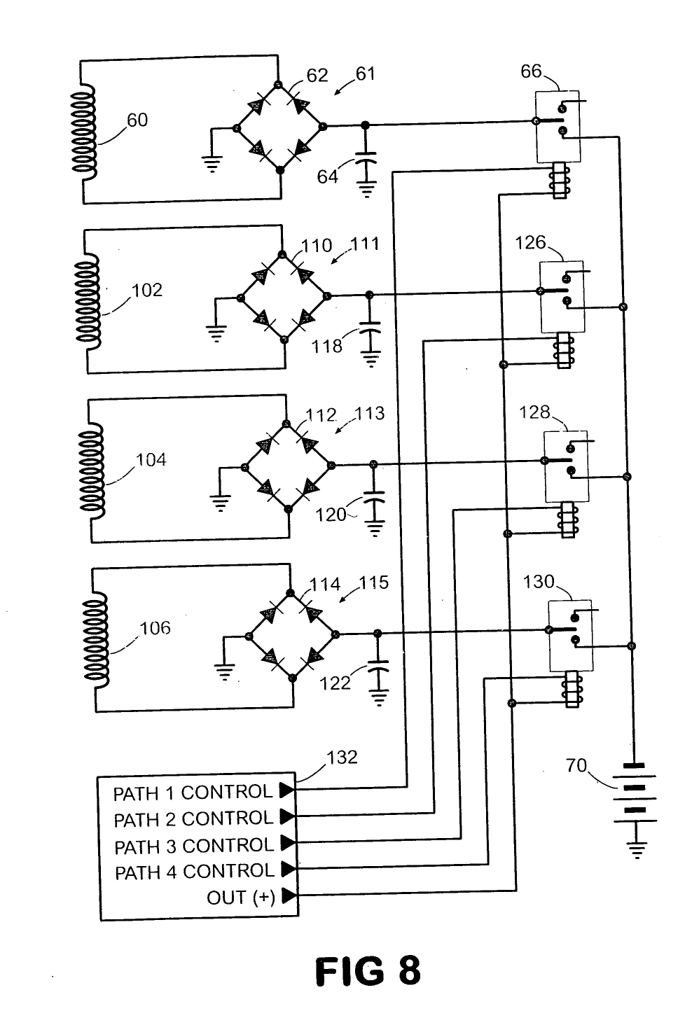

FIG. 7 is a circuit diagram for a shock absorber assembly that has a primary linear generator and two secondary linear generators as illustrated in FIG. 4. Similar to the system described above in relation to FIG. 6, the primary linear generator 72 is coupled to a first filter 75 that filters converted energy from the primary linear generator 72 and operatively outputs filtered energy to the battery 98. The first filter 75 includes, for example, a bridge rectifier circuit 78 and a capacitor 84. The filtered energy from the first filter 75 is received by a first switch 90 that connects or disconnects the linear generator 72 to the battery 98.

A first secondary linear generator 74 is connected to a second filter 85, which includes, for example, a bridge rectifier circuit 80 and a capacitor 86. The second filter 85 is connected to a second switch 92 that connects or disconnects the first secondary linear generator 74 to the battery 98. A second secondary linear generator 76 is connected to a third filter 87, which includes, for example, a bridge rectifier circuit 82 and a capacitor 88. The third filter 87 is connected to a third switch 94 that connects or disconnects the second secondary linear generator 76 to the battery 98. The processing device 96 is connected to the first, second, and third switches 90, 92, 94, and is capable of sensing first, second, and third filtered energy from the first, second, and third filters 75, 85, 87, respectively. The processing device 96 is also capable of determining whether to connect or disconnect the primary linear generator 72 and the first and second secondary linear generators 74, 76 to the battery 98 based upon the first, second, and third filtered energy from the first, second, and third filters 75, 85, 87, respectively. In addition, the processing device 96 is capable of controlling the first, second, and third switches 90, 92, 94 to connect or disconnect the primary linear generator 72 and the first and second secondary linear generators 74, 76 to the battery 98.

The processing device 96 can be programmed to connect to the primary linear generator 72 to the battery 98 when a large bump in the road is encountered. It may be necessary to have a sensor on the shock absorber to anticipate a big bump and to send that message to the processing device 96. For small bumps in the road, the first and second secondary linear generators 74 and 76 are more appropriately used. Obviously, the processing device 96 can be programmed to best meet the electrical needs of the vehicle.

FIG. 8 is a circuit diagram for four separate linear generator shock absorbers as would be found on a four wheel vehicle. The circuit diagram in FIG. 8 includes similar electrical components described above in relation to FIG. 6 and therefore includes a linear generator shock absorber 60, filter 61, capacitor 64, switch 66, and battery 70. The circuit diagram of FIG. 8 further includes a second linear generator shock absorber 102 that is connected to a second filter 111, which includes, for example, a bridge rectifier circuit 110 and a capacitor 118. The second filter 111 is connected to a second switch 126 that connects or disconnects the second linear generator shock absorber 102 to the battery 70.

A third linear generator shock absorber 104 is connected to a third filter 113, which include, for example, a bridge rectifier circuit 112 and a capacitor 120. The third filter 113 is connected to a third switch 128 that connects or disconnects the third linear generator shock absorber 104 to the battery 70. A fourth linear generator shock absorber 106 is connected to a fourth filter 115, which include, for example, a bridge rectifier circuit 114 and a capacitor 122. The fourth filter 115 is connected to a fourth switch 130 that connects or disconnects the fourth linear generator shock absorber 106 to the battery 70.

A processing device 132 is connected to the first, second, third, and fourth switches 66, 126, 128, 130, and is capable of sensing a first, second, third, and fourth filtered energy from the first, second, third, and fourth filters 61, 111, 113, 115, respectively. The processing device 132 is also capable of determining whether to connect or disconnect the linear generator shock absorbers 60, 102, 104, 106 to the battery 70 based upon the first, second, third, and fourth filtered energy from the first, second, third and fourth filters 61, 111, 113, 115. In addition, the processing device 132 is capable of controlling the first, second, third, and fourth switches 66, 126, 128, 130 to connect or disconnect the linear generator shock absorbers 60, 102, 104, 106 to the battery 70.

It should be realized that each of the shock absorbers 60, 102, 104, and 106 could have a secondary shock absorber as illustrated in FIG. 7. The processing device 132 in FIG. 8 can determine whether to permit current flow from a primary or secondary shock absorber to the battery 70. The processing device can also be programmed so that only some of the shock absorbers are supplying energy to the battery. The processing device 132 can also direct the flow of current to any electric motor for powering the vehicle or to another electrical appliance.

It should be noted that the processing devices 68, 96, 132 are connected to the battery via the switches and are capable of determining the state of charge (SOC) of the battery and/or the battery charge acceptance (BCA) of the battery, and then charging the battery in a manner which is responsive to the determined SOC/BCA of the battery. This is disclosed in U.S. Pat. No. 6,094,033, to Ding et al., and U.S. Pat. No. 6,229,285, to Ding, which are all herein incorporated by reference.

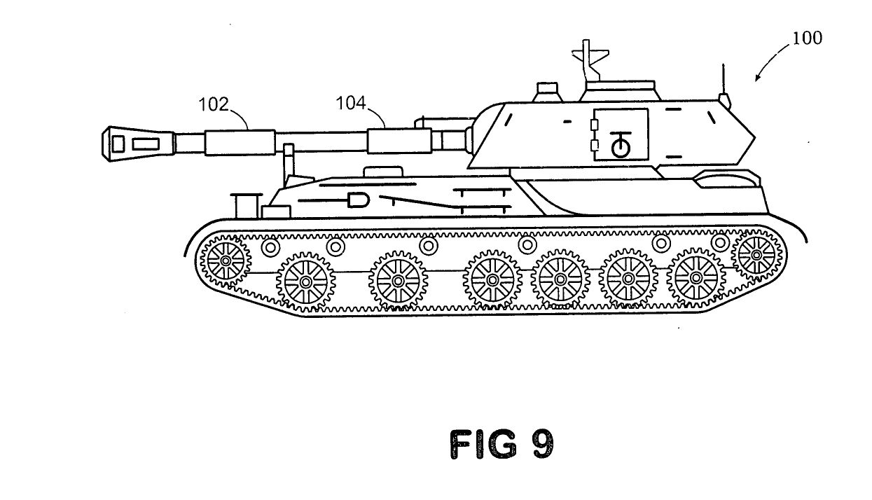

FIG. 9 illustrates a self-propelled howitzer 100. This howitzer has a barrel 102 which recoils each time the gun is fired. As in the case of the shock absorber shown in FIG. 1, coils can be wrapped around a gun sleeve 104 to form a linear generator for generating electric power for the self-propelled gun when it is fired. This replaces, in whole or part, the hydraulic dampening arrangement in the howitzer for absorbing the recoil.

The linear generator of this invention can be used to capture the energy expended in the recoil of the barrel of a large gun when fired. The electric coils can be wrapped around a portion of the barrel and held in a stationary position on the gun carriage while the barrel recoils. The linear generator can generate electricity from the recoil for supplying the electrical needs connected with the operation of the large gun.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

1. A system for capturing and storing electrical energy from irregular limited reciprocal linear movements along a length of a cylinder, the system comprising:
a. a linear generator with electrical coils wound around at least a substantial portion of the length of the cylinder parallel to the movement along the cylinder, said coils being supported in a stationary position in relation to the movement along the cylinder, said linear generator being capable of converting at least a substantial portion of the energy of the movement along the cylinder into electricity;
b. a battery for receiving and storing the electrical energy generated by the linear generator; and
c. an electrical connection between the linear generator and the battery for the flow of electrical current from the generator to the battery.

2. The system of claim 1 in which the cylinder is a portion of the cylinder of a shock absorber for a vehicle which is designed to absorb the shocks transmitted when the vehicle is moving on terrain with irregularities in the surface, the linear generator including a piston that moves along the length of the cylinder as the vehicle moves on the terrain and encounters irregularities in the surface, the electric coils of linear generator being wrapped around the cylinder parallel to the movement of the piston, the linear generator being capable of converting at least a substantial portion of the energy of movement of the piston into electricity, the linear generator being connected to a filter that filters the converted energy and operatively outputs filtered energy to the battery, the filter being connected to a switch that connects or disconnects the linear generator to the battery.

3. The system of claim 1 in which the cylinder is a barrel of a gun which is capable of recoiling when fired, the electric coils of the linear generator wrapped around at least a portion of the barrel and parallel to the movement of barrel during recoil of the barrel, the coils being stationary in relation to the movement of the barrel during recoil, the linear generator being capable of converting at least a substantial portion of the energy of movement of the barrel during recoil into electricity.

4. The system of claim 1, further comprising a filter that is connected to the linear generator that filters the converted energy and operatively outputs filtered energy to the battery.

5. The system of claim 4-7, wherein the filter includes a bridge rectifier circuit and a capacitor.

6. The system of claim 4, further comprising a switch that connects or disconnects the linear generator to the battery.

7. The system of claim 6, further comprising a processing device that is connected to the switch and is capable of sensing the filtered energy from the filter, the processing device being capable of determining whether to connect or disconnect the linear generator to the battery.

8. The system of claim 7, further comprising a second linear generator that is connected to a second filter, the second filter being connected to a second switch that connects or disconnects the second linear generator to the battery, the processing device being connected to the second switch and is capable of sensing a second filtered energy from the second filter, the processing device being capable of determining whether to connect or disconnect the linear generator and second linear generator to the battery based on the filtered energy and the second filtered energy.

9. The system of claim 8, further comprising a third linear generator and a fourth linear generator, the third linear generator being connected to a third filter, the third filter being connected to a third switch that connects or disconnects the third linear generator to the battery, the fourth linear generator being connected to a fourth filter, the fourth filter being connected to a fourth switch that connects or disconnects the fourth linear generator to the battery, the processing device being connected to the third and fourth switches and is capable of sensing a third filtered energy and a fourth filtered energy from the third and fourth filters, respectively, the processing device being capable of determining whether to connect or disconnect the linear generator and the first, second, third and fourth linear generators to the battery, based on the first, second, third and fourth filtered energy.

10. The system of claim 9, wherein the four linear generators are part of four shock absorbers as would be found on a four wheel vehicle.

11. The system of claim 7, further comprising a first secondary linear generator and a second secondary linear generator, the first secondary linear generator being connected to a first filter, the first filter being connected to a first switch that connects or disconnects the first secondary linear generator to the battery, the second secondary linear generator being connected to a second filter, the second filter being connected to a second switch that connects or disconnects the second secondary linear generator to the battery, the processing device being connected to the first and second switches and is capable of sensing a first filtered energy and a second filtered energy from the first and second secondary filters, respectively, the processing device being capable of determining whether to connect or disconnect the linear generator and the first and second secondary linear generators to the battery based on the first and second secondary filtered energy.

12. The system of claim 1, further comprising a power conditioner that stores the energy in a form that can be used by a power management system.

13. The system of claim 12; wherein the power conditioner includes a capacitor.

14. The system of claim 13, further comprising a switching regulator can be used to transform voltage of the capacitor to match voltage of the end using system.

15. The system of claim 14, wherein the end using system is a battery.

16. The system of claim 2, further comprising a processing device that is connected to the switch and is capable of sensing the filtered energy from the filter, the processing device being capable of determining whether to connect or disconnect the linear generator to the battery.

17. The system of claim 16, further comprising a power conditioner that stores the energy in a form that can be used by a power management system.

18. The system of claim 17, further comprising a switching regulator can be used to transform voltage of the capacitor to match voltage of the end using system.

19. The system of claim 18, wherein the end using system is a battery.

20. The system of claim 9, further comprising a power conditioner that stores the energy in a form that can be used by a power management system.
